(19) United States
(12) Patent Application Publication
(10) Pub. No.: US 2023/0051871 A1
(43) Pub. Date: Feb. 16, 2023

(54) DISTRIBUTED OPTIMIZATION METHOD OF REGIONAL INTEGRATED ENERGY CONSIDERING DIFFERENT BUILDING HEATING MODES

(71) Applicant: NORTHEAST ELECTRIC POWER UNIVERSITY, Jilin City (CN)

(72) Inventors: Rufeng ZHANG, Jilin City (CN); Houhe CHEN, Jilin City (CN); Tao JIANG, Jilin City (CN); Yutong ZHANG, Jilin City (CN); Xue LI, Jilin City (CN); Guoqing LI, Jilin City (CN); Changjiang WANG, Jilin City (CN); Benxin LI, Jilin City (CN)

(21) Appl. No.: 17/576,631

(22) Filed: Jan. 14, 2022

(30) Foreign Application Priority Data
Aug. 5, 2021 (CN) 202110895140X

(51) Int. Cl. G06Q 50/06; F24F 11/63; F24F 110/10

(52) U.S. Cl. CPC G06Q 50/06; F24F 11/63; F24F 2110/10

(57) ABSTRACT

The present invention discloses a distributed optimization method of regional integrated energy considering different building heating modes, comprising: based on a heating resistance and heat capacity network model, building an RIEDHS optimal scheduling model considering different building heating modes; by a coordination operator, initializing a Lagrange multiplier and global variable information and sending related information to an electricity sub-network and a heating sub-network which perform internal local optimization according to respective sub-problems and return coupling variable information to the coordination operator; and by the coordination operator, receiving the coupling variable information from the electricity sub-network and the heating sub-network, judging whether a convergence condition is met according to the coupling variable information and global variable information: ending the process if so, otherwise updating the Lagrange multiplier and a global variable, and re-executing the local optimization step until the convergence condition is met.

### CROSS-REFERENCE TO RELATED APPLICATION

This application claims priority from the Chinese patent application 202110895140X filed Aug. 5, 2021, the content of which is incorporated herein in the entirety by reference.

### TECHNICAL FIELD

The present invention relates to the field of modeling and optimal control of regional integrated energy systems, in particular to a distributed optimization method of regional integrated energy considering different building heating modes.

### BACKGROUND ART

With the continuous development of distributed generation technologies, the correlation between power distribution networks and district heating networks is getting closer and closer. Regional integrated electricity and district heating systems (RIEDHS) has become one of the important application scenes of integrated energy systems [¹]. In recent years, the energy consumption of global residents and commercial buildings has been rising continuously, reaching 20% to 40% in developed countries ^{[2] [3]}. Due to high consumption and inherent heating inertia, buildings have a great potential in providing flexible demands, which can deliver more flexibility to the coordinated operations of RIEDHS ^{[4]}.

At present, methods of regional integrated energy optimal scheduling often ignore heating inertia of buildings. Based on inherent heat insulation performance of the buildings, indoor temperatures of the buildings will not suddenly change, so that heating areas in each building can serve as heat storage units. Meanwhile, according to different heating modes in the buildings, the buildings can be subdivided into residential buildings, commercial buildings and other categories to improve accuracy of simulation. Therefore, considering the heating inertia of buildings can provide the RIEDHS with more operational flexibility, thereby reducing operating cost.

At present, centralized solutions are often adopted for the optimal scheduling problem of RIEDHS, which will cause phenomena of complicated calculation and difficult communication in practice. Under the centralized solutions, optimal scheduling of the RIEDHS is separately controlled by a joint operator (JO) through a centralized model. In fact, the RIEDHS has the characteristics of multi-energy coupling and multi-entity operation. District heating systems (DHS) and power grids belong to different operating entities, which are controlled and managed by heat operators (HO) and electricity operators (EO) respectively, and commanded by a coordination operator (CO). System operation data of one operating entity has certain privacy for other operating entities. Obviously, the traditional centralized solution is no longer suitable for a multi-decision-maker architecture, and the work of using distributed methods to solve the coordination problem between the DHS and power grids is still very limited.

Therefore, it is of great importance to study and develop a distributed method to solve the optimal scheduling problem of the RIEDHS.

### SUMMARY OF THE INVENTION

The present invention provides a distributed optimization method of regional integrated energy considering different building heating modes, which can not only protect privacy of different operating entities in RIEDHS, but can also improve photovoltaic consumption to a certain extent, as described below in detail.

A distributed optimization method of regional integrated energy considering different building heating modes, comprising:

based on a heating resistance and heat capacity network model, building an RIEDHS optimal scheduling model considering different building heating modes according to building heat storage characteristics and different heat energy supply forms in a room;

by a coordination operator, initializing a Lagrange multiplier and global variable information and sending related information to an electricity sub-network and a heating sub-network, which perform internal local optimization according to respective sub-problems and return coupling variable information to the coordination operator;

by the coordination operator, receiving the coupling variable information from the electricity sub-network and the heating sub-network, judging whether a convergence condition is met according to the coupling variable information and global variable information: ending the process if so, otherwise updating the Lagrange multiplier and a global variable, and re-executing the local optimization step until the convergence condition is met.

Based on the heating resistance and heat capacity network model, building the

RIEDHS optimal scheduling model considering the different building heating modes specifically comprises:

1) Building an indoor heat balance constraint of commercial buildings and residential buildings:

$${C}_{i}^{r} \frac{{dT}_{i}^{r}}{dt} = {\sum }_{j ∈ {N}_{i}^{r}} \frac{{T}_{i , j}^{w} - {T}_{i}^{r}}{{R}_{i , j}^{w}} + {π}_{i , j}^{r} {\sum }_{j ∈ {N}_{i}^{r}} \frac{{T}_{j} - {T}_{i}^{r}}{{R}_{i , j}^{win}} + {Q}_{i}^{int} + {Q}_{R , i} + {π}_{i , j}^{r} {τ}_{i , j}^{w} {A}_{i , j}^{win} {Q}_{i}^{rad}$$

$${C}_{i}^{r} \frac{{dT}_{i}^{r}}{dt} = {\sum }_{j ∈ {N}_{i}^{r}} \frac{{T}_{i , j}^{w} - {T}_{i}^{r}}{{R}_{i , j}^{w}} + {π}_{i , j}^{r} {\sum }_{j ∈ {N}_{i}^{r}} \frac{{T}_{j} - {T}_{i}^{r}}{{R}_{i , j}^{win}} + {Q}_{i}^{int} + {m}_{i}^{HVAC} {c}_{pair} ( {T}_{i}^{HVACs} - {T}_{i}^{r} ) + {π}_{i , j}^{r} {τ}_{i , j}^{w} {A}_{i , j}^{win} {Q}_{i}^{rad}$$

Where: C′ᵢ is a heat capacity of an indoor room; T′ᵢ is an indoor room temperature; π′_{i,j} is equal to 0, which indicates that there is no window on walls of the indoor room, otherwise the value is 1; Qᵢₙₜᵢ is an internal heat source of the room; R_{i,j}^{win} is heating resistance of the window; mᵢ^{HVAC} is an air supply mass flow of an HVAC system; Cₚₐᵢᵣ is a specific heat capacity of air; Tᵢ^{HVACs} is an air supply temperature; T_{i,j}^{w} is transmittance of the window; A_{i,j}^{win} represents the total area of the window; Q_{R,i} is a heating power required by the residential building; is the intensity of illumination radiation;

2) Building an aggregation formula of the commercial buildings and the residential buildings:

$${P}_{j}^{EEn} \cdot {η}_{EEn} = {\sum }_{i = 1}^{{N}_{EB μ}} {P}_{t}^{HVAC}$$

$${Φ}_{j}^{HEn} \cdot {η}_{HEn} = {\sum }_{i = 1}^{{N}_{HB μ}} {Q}_{R , i}$$

Where: Pⱼ^{EEn} is an electric load of the commercial building matched to a power distribution sub-network; Φⱼ^{HEn} is a heat load of the residential building matched to a heating sub-network; η_{EEn} and η_{HEn} are conversion coefficients of the commercial building and the residential building respectively; N_{EBu} is a set of the commercial buildings; and N_{HBu} is a set of the residential buildings.

Further, the step that the electricity sub-network and the heating sub-network perform internal local optimization according to respective sub-problems specifically comprises:

using an ADMM to complete information interactions among operating entities in a distributed way, wherein a main problem is transformed into sub-problems of the electricity sub-network and the heating sub-network, and the electricity sub-network and the heating sub-network perform internal local optimization according to the respective sub-problems.

Using the ADMM to complete the information interactions among the operating entities specifically comprises:

establishing an RIEDHS distributed optimal scheduling model considering different building heating modes, and inputting required related parameters;

by a CO, initializing a Lagrange multiplier (λ_{mn,i}, λ_{mn,j}) and a global variables (zₘₙ) of each subregion and sending information to an EO and a HO of lower layers;

after receiving the coupling information, by the EO and HO of the lower layers, conducting internal local optimization to obtain all information (x _{E}^{k+1}, x_{H}^{k+1}) of electrothermal coupling equipment, and then by the EO and HO, respectively sending the information of the electrothermal coupling equipment back to the CO; and by the CO, judging convergence of the ADMM after receiving the information of the electrothermal coupling equipment sent by the EO and HO, wherein iteration is stopped if a dual residual and an original residual are less than a threshold;

∥s^{k+1}∥₂²=∥x_{E/H}^{k+1}−zₘₙ^{k+1}∥₂²≤ε₁

∥r^{k+1}∥₂²=∥(−ρ)(zₘₙ^{k+1}−zₘₙ^{k})∥₂²≤ε₂

If a convergence condition is not met, the CO updates the global variable and the Lagrange multiplier, and then sends the updated information back to the EO and HO until the ADMM converges and the cycle ends.

zₘₙ^{k+1}=(1/2)(x_{E}^{k+1}+x_{H}^{k+1})

λ_{mn,i}^{k+1}=λ_{mn,i}^{k}+ρ(x_{E}^{k+1}−zₘₙ^{k+1})

λ_{mn,j}^{k+1}=λ_{mn,j}^{k}+ρ(x_{H}^{k+1}−zₘₙ^{k+1}).

The technical solution provided by the present invention has the beneficial effects that:
1. The present invention integrally considers dynamic characteristics of district heating systems (DHS) and the heating inertia of THE buildings, and builds the distributed RIEDHS optimal scheduling model, which has a positive effect on reducing operating cost of the RIEDHS and improving photovoltaic consumption;
2. Considering the different heating modes inside the buildings, the present invention distinguishes commercial buildings from residential buildings and takes the buildings as heat storage units with limited capacities, and integrates the buildings with the different heating modes into the RI DHS by adjusting a magnitude of the electric heating loads of the buildings to match the electric heating loads that the RIDHS can supply, so that a response capability of energy storage characteristics in the building heating areas can provide additional operation flexibility for the RIDHS; and
3. According to the present invention, the ADMM method is introduced into the RIEDHS to solve the distributed optimization problem of the multi-entity operation system, so as to effectively protect the internal privacy of the different operating entities and reduce the information interactions among the different operating entities; and the alternating direction multiplier method in the form of variable penalty parameters can effectively improve convergence performance of the algorithm and reduce dependence on initial values of penalty parameters, thereby further improving calculation efficiency.

### BRIEF DESCRIPTION OF THE DRAWINGS

FIG. 1 is a flow chart of a distributed optimization method of regional integrated energy considering different building heating modes;

FIG. 2 is a schematic diagram of a distributed optimization framework of an RIEDHS;

FIG. 3 is a network topology diagram of an E33D6 test system;

FIG. 4 is a comparison chart of indoor temperatures of buildings; and

FIG. 5 is an iterative curve graph of an E33D6 test system.

### DETAILED DESCRIPTION OF THE INVENTION

In order to make the purposes, technical solutions and advantages of the present invention clearer, the embodiments of the present invention are further described below in detail.

### Embodiment 1

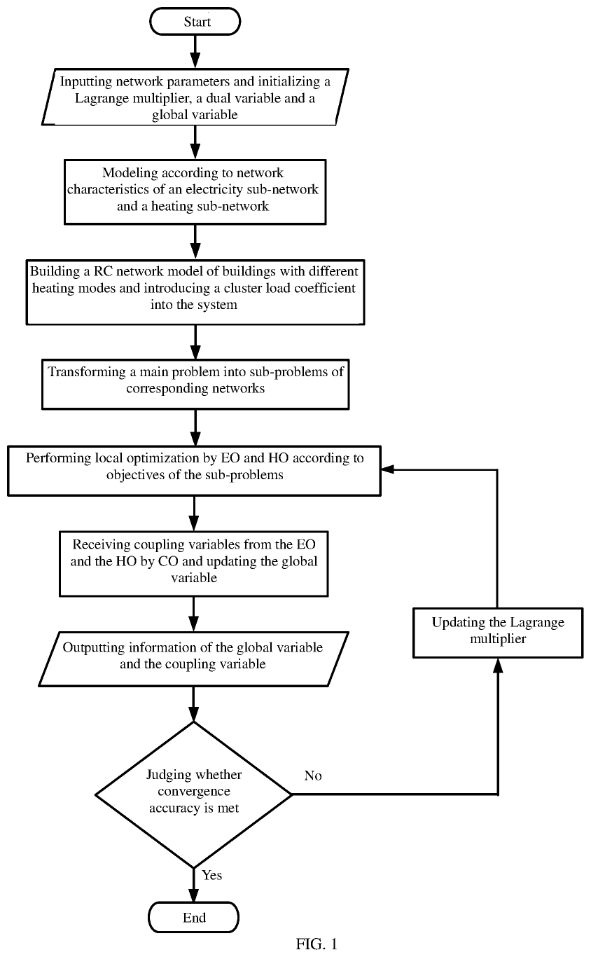

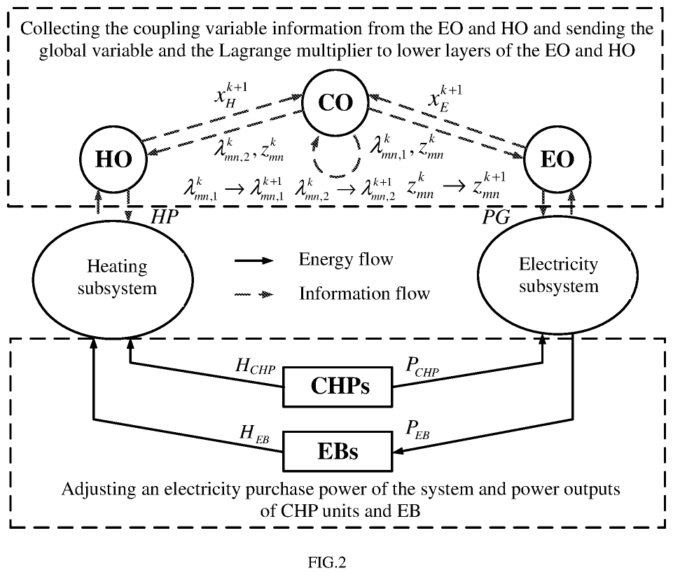

The embodiment of the present invention provides a distributed optimization method of regional integrated energy considering different building heating modes. As shown in FIG. 1 and FIG. 2, the method comprises the following steps:
101: According to a characteristic that an electricity subsystem has a radial network, a DistFlow model suitable for a radial network structure is adopted for modeling; and considering heat loss in a process of heat transfer, a heating sub-network is modeled, and two sub-networks are coupled by a CHP unit to build an RIEDHS optimal scheduling model.
102: According to building heat storage characteristics and different heat energy supply forms in a room, based on a heating resistance and heat capacity network model, the RIEDHS optimal scheduling model considering different building heating modes is built;
103: A main problem is transformed into sub-problems of the electricity sub-network and the heating sub-network, and the electricity sub-network and the heating sub-network perform internal local optimization according to the respective sub-problems, and transmit coupling variable information to a CO (coordination operator);
104: The CO receives the coupling variable information from the electricity sub-network and the heating sub-network, updates a global variable, judges whether a convergence condition is met according to the output coupling variable information and global variable information: ending the process if so, otherwise updating a Lagrange multiplier, re-executing the step 103 and conducting a next time of iterative calculation until the convergence condition is met.

Conclusively, according to the above steps 101-104 and the known external environmental parameters, the embodiment of the present invention puts forward a distributed optimization method of regional integrated energy considering different building heating modes by using an ADMM method based on protecting privacy of different operating entities, and further compares and analyzes influences of the buildings with different heating modes on economic efficiency and a photovoltaic consumption of an RIEDHS.

### Embodiment 2

Next, the solution in Embodiment 1 is further introduced in combination with specific calculation formulas and Embodiments. See the following description for details:
201: According to the characteristic that an electricity subsystem has a radial network, a DistFlow model suitable for a radial network structure is adopted for modeling;

The step 201 comprises:

1) building a DistFlow constraint of the electricity subsystem:

$${\sum }_{i ∈ {m}_{1} ( j )} ( {P}_{ij} - {l}_{ij} {r}_{ij} ) - {\sum }_{k ∈ {m}_{2} ( j )} {P}_{jk} + {P}_{j , G} - {P}_{j , d} = 0 \qquad ( 1 )$$

$${\sum }_{i ∈ {m}_{1} ( j )} ( {Q}_{ij} - {l}_{ij} {x}_{ij} ) - {\sum }_{k ∈ {m}_{2} ( j )} {Q}_{jk} + {Q}_{j , G} - {Q}_{j , d} = 0 \qquad ( 2 )$$

$${u}_{i} - {u}_{j} = 2 ( {r}_{ij} {P}_{ij} + {x}_{ij} {Q}_{ij} ) - ( {( {r}_{ij} )}^{2} + {( {x}_{ij} )}^{2} ) {l}_{ij} \qquad ( 3 )$$

$$‖ 2 \begin{matrix}{P}_{ij} & 2 {Q}_{ij} & {l}_{ij} - {u}_{i} ‖ = {l}_{ij} + {u}_{i}\end{matrix} \qquad ( 4 )$$

Where Pᵢⱼ, Qᵢⱼ, Pⱼₖ and Qⱼₖ are active powers and reactive powers of an electricity subsystem line; rᵢⱼ and xᵢⱼ are resistance and reactance between nodes i and j; lᵢⱼ is a square of a current between the nodes i and j; P_{j,G}, and Q_{j,G} are an active power and a reactive power injected by the node; P,_{d}, andq_{d} are an active load and a reactive load of the node; u, represents a square of a voltage of node i, and uⱼ represents a square of a voltage of node j directly connected to node i; m₁(j) is an initial node set of a distribution line of the terminal node j; m₂(j) is a terminal node set of the distribution line of the initial node j; and k is a node number.

In the above model, only the constraint (4) is non-convex and the rest constraints are linear. The constraint is relaxed into a second-order cone constraint by using a second-order cone relaxation method, and the relaxed constraint is:

∥2Pᵢⱼ 2Qᵢⱼ lᵢⱼ−uᵢ∥≤lᵢⱼ+uᵢ (5)

2) Building a constraint of the electricity subsystem voltage and a generator output:

(V_{i,min})²≤uᵢ≤(V_{i,max})² (6)

P_{G,i,min}≤P_{G,i,min}≤P_{G,i,max} (7)

Q_{G,i,min}≤Q_{G,i}≤Q_{G,i,max} (8)

Where C_{i,min} and V_{i,max} represent lower and upper limits of the node i voltage; P_{G,i,min} and P_{G,i,max} represent lower and upper limits of the active power output by the generator; Q_{G,i,min} and Q_{G,i,max} presett lower and upper limits of the reactive power output by the generator, and are the active power and reactive power injected into the generator.

3) Building an output constraint of the photovoltaic generator:

0≤P_{pvi,t}≤P_{pvi,t,max} (9)

|P_{pvi,t}|≤\sqrt{Sₚᵥᵢ−(Q_{pvi,t})²} (10)

Where P_{pvi,t} is active output of photovoltaic power generation equipment; P_{pvi,t,max} is an upper limit of the active output of the photovoltaic generator; and Sₚᵥᵢ and Q_{pvi,t} are an apparent power and an instantaneous reactive power of the photovoltaic generator.

202: Considering heat loss in a process of heat transfer, a heating sub-network is modeled;

The step 202 comprises:

1) Building an output constraint of a CHP unit:

$${P}_{CHPi , t} = {\sum }_{k = 1}^{{N}_{t}} {α}_{i , t}^{k} {P}_{corner , i}^{k} , ∀ i ∈ {N}_{CHP} \qquad ( 11 )$$

$${H}_{CHPi , t} = {\sum }_{k = 1}^{{N}_{t}} {α}_{i , t}^{k} {H}_{corner , i}^{k} , ∀ i ∈ {N}_{CHP} \qquad ( 12 )$$

$$0 \leq {α}_{i , t}^{k} \leq 1 , {\sum }_{k = 1}^{{N}_{t}} {α}_{i , t}^{k} = 1 , ∀ i ∈ {N}_{CHP} , k ∈ \{ 1 , 2 , … , {N}_{t} \} \qquad ( 13 )$$

$${n}_{{CH}_{4} i , t} = \frac{{P}_{CHPi , t} Δ t}{{η}_{CHP} {LHV}_{{CH}_{4}}} \qquad ( 14 )$$

Where P_{CHPi,t}, H_{CHPi,t} are an electric power and a heating power output by the CHP unit, P_{corner,j}^{k} and H_{kcorner,i} are an electric power output and a heating power output of an extreme value point, that is, a boundary intersection of an electrothermal characteristic curve, wherein k=1,2,3. . . Nₜ, Nₜ represents the number of extreme points; a_{i,t}^{k} is an operating point within the electrothermal characteristic curve of the CHP unit; η_{CHP} is working efficiency of the CHP unit; LHV_{CH4} is a low heating value of natural gas; N_{CHP} is a set of the CHP units; and n_{CH}_{₄}_{i,t} is a total amount of natural gas purchased for the system.

2) Building a heating power balance equation of a heat source node and a heat load node:

Φ_{CHP,i}=Cₚm_{q}^{HS}(Tₛ^{HS}−Tᵣ^{HS}) (15)

Φ_{HE,i}=Cₚm_{q}^{HE}(Tₛ^{HE}−Tᵣ^{HE}) (16)

Where Φ_{CHP,i}, and Φ_{HE,i} are heating powers of the heat source node and the heat load node respectively; Cₚ is a specific heat capacity of hot water; m_{q}^{HS} and m_{q}^{HE} are hot water mass flows at the heat source node and the heat load node; and Tₛ^{HS}, Tᵣ^{HS}, Tₛ^{HE}, and T_{HEr} are heating temperatures and back-heating temperatures at the heat source node and the heat load node.

3) Building a related constraint of a heating network pipeline:

$${\sum }_{i ∈ {S}_{ps}} ( {T}_{i , t}^{s , out} {m}_{i , t}^{s} ) = {T}_{mixn , t}^{s} {\sum }_{i ∈ {S}_{ps}} {m}_{i , t}^{s} \qquad ( 17 )$$

$${\sum }_{i ∈ {S}_{pr}} ( {T}_{i , t}^{r , out} {m}_{i , t}^{r} ) = {T}_{mixn , t}^{r} {\sum }_{i ∈ {S}_{pr}} {m}_{i , t}^{r} \qquad ( 18 )$$

$${T}_{i , t}^{end} = ( {T}_{i , t}^{start} - {T}_{a , t} ) {e}^{- \frac{λ L}{{C}_{p} {m}_{q}}} + {T}_{a , t} \qquad ( 19 )$$

$${T}_{i , min}^{s} \leq {T}_{i , t}^{s} \leq {T}_{i , max}^{s} \qquad ( 20 )$$

$${T}_{i , min}^{r} \leq {T}_{i , t}^{r} \leq {T}_{i , max}^{r} \qquad ( 21 )$$

Where T_{i,j}^{s,out}, T_{i,j}^{r,out} respectively represent water outlet temperatures of a heating pipeline node and a back-heating pipeline node; m_{i,t}^{s} and m_{i,t}^{r} respectively represent hot water mass flow rates of a heating pipeline and a back-heating pipeline; T_{mixn,t}^{s} and T_{mixn,t}^{r} respectively represent temperatures of mixing nodes of the heating pipeline and the back-heating pipeline; T_{i,t}^{start} and T_{i,t}^{end} respectively represent temperatures of an inlet and an outlet of the pipeline; T_{a,t} is an outer ambient temperature; A is a heat dissipation coefficient of the pipeline; L is the length of the heating pipeline; T_{i,t}^{s} and T_{i,t}^{t} are temperatures of the heating node and the back-heating node; T_{i,max}^{s} and T_{i,min}^{s} are upper and lower limits of a heating temperature; T_{i,max}^{r} and T_{i,min}^{r} are upper and lower limits of a back-heating temperature, and m_{q} is a mass flow rate in the pipeline.

203: Based on a heating resistance and heat capacity network model, building models with different heating modes are built according to building heat storage characteristics and different heat energy supply forms in a room;

Step 203 comprises:

1) Building a wall heat balance constraint of a single heating area:

The heating resistance and heat capacity network model consists of heating resistance with the ability to transfer heat and heat capacity with the ability to save heat. Nodes in each heating area of the building are divided into wall nodes and indoor air nodes, which are connected to each other by heating resistance and grounded by heat capacity. In addition, the building model takes a single building as a unit, and the heating resistance and heat capacity network model describes a single heating area, so the building model is composed through aggregation of a plurality of heating areas with a similar structure.

$${C}_{i , j}^{w} \frac{{dT}_{i , j}^{w}}{dt} = {\sum }_{j ∈ {N}_{i , j}^{w}} \frac{{T}_{j} - {T}_{i , j}^{w}}{{R}_{i , j}^{w}} + {π}_{i , j}^{w} {α}_{i , j}^{w} {A}_{i , j}^{w} {Q}_{i , j}^{rad} \qquad ( 22 )$$

Where C_{wij} is the heat capacity of a wall; Tⱼ is a temperature of an adjacent node; T_{i,j}^{w} is a temperature of each wall; if the wall is not irradiated by light, π_{i,j}^{w} is 0, otherwise the value is 1; a_{i,j}^{w} is a heat absorption rate of the wall; A_{i,j}^{w} is the area of the wall; Q_{radi,j} is the light intensity of a corresponding direction of the wall; R wᵢⱼ is the heating resistance between indoor air node and the wall; and N_{wij} is a set of the adjacent nodes of the j-th wall.

2) Building an indoor heat balance constraint of commercial buildings and residential buildings:

Considering the different heating modes inside the buildings, the buildings are subdivided into residential buildings, commercial buildings and other categories. Under same lighting environment parameters, a Heating, Ventilation and Air Conditioning (HVAC) system power of each heating area in the commercial building is consistent; and a hot water heating power of each heating area in the residential building is consistent. On the basis, through a building heating system, air supply parameters of HVAC equipment and water supply and water return temperatures of heating users are adjusted, so as to satisfy the users' requirements for comfort. Every heating area of the commercial building consumes electricity by the HVAC system to maintain the users' comfort. Each heating area of the residential building uses hot water from a heat exchange station to maintain the users' comfort.

$${C}_{i}^{r} \frac{d {T}_{i}^{r}}{dt} = {\sum }_{j ∈ {N}_{i}^{r}} \frac{{T}_{i , j}^{w} - {T}_{i}^{r}}{{R}_{i , j}^{w}} + {π}_{i , j}^{r} {\sum }_{j ∈ {N}_{i}^{r}} \frac{{T}_{j} - {T}_{i}^{r}}{{R}_{i , j}^{win}} + {Q}_{i}^{int} + {Q}_{R , i} + {π}_{i , j}^{r} {τ}_{i , j}^{w} {A}_{i , j}^{win} {Q}_{i}^{rad} \qquad ( 23 )$$

$${C}_{i}^{r} \frac{{dT}_{i}^{r}}{dt} = {\sum }_{j ∈ {N}_{i}^{r}} \frac{{T}_{i , j}^{w} - {T}_{i}^{r}}{{R}_{i , j}^{w}} + {π}_{i , j}^{r} {\sum }_{j ∈ {N}_{i}^{r}} \frac{{T}_{j} - {T}_{i}^{r}}{{R}_{i , j}^{win}} + {Q}_{i}^{int} + {m}_{i}^{HVAC} {c}_{pair} ( {T}_{i}^{{HVAC}_{s}} - {T}_{i}^{r} ) + {π}_{i , j}^{r} {τ}_{i , j}^{w} {A}_{i , j}^{win} {Q}_{i}^{rad} \qquad ( 24 )$$

Where Cᵢ^{r} is heat capacity of an indoor room; Tᵢ^{r} is an indoor room temperature; π_{i,j}^{r} is equal to 0, which indicates that there is no window on the wall of the indoor room, otherwise the value is 1; Qᵢₙₜᵢ is an internal heat source of the room; R_{i,j}^{win} is heating resistance of the window; mᵢ^{HVAC} is an air supply mass flow rate of the HVAC system; Cₚₐᵢᵣ is a specific heat capacity of air; Tᵢ^{HVACs} is an air supply temperature, τ_{wi,l} is transmittance of the window; A_{i,j}^{win} represents the total area of the window; Q_{R,i} is a heating power required by the residential buildings; and Qᵢ^{rad} is the intensity of illumination radiation.

Meanwhile, the HVAC system should also meet relevant constraints:

$${P}_{t}^{HVAC} = {P}_{t}^{h} + {P}_{t}^{f} \qquad ( 25 )$$

$${P}_{t}^{h} = \frac{{m}_{i}^{HVAC} {c}_{pair} ( {T}_{i}^{HVACs} - {T}_{i}^{r} )}{COP} \qquad ( 26 )$$

$${P}_{t}^{f} = \frac{{m}_{i}^{HVAC} Δ {P}_{tot}}{{η}_{fan} {η}_{motor}} \qquad ( 27 )$$

$$Δ {P}_{tot} = {P}_{static} + {ρ}_{air} \frac{{v}^{2}}{2} \qquad ( 28 )$$

$${m}_{i}^{min} \leq {m}_{i}^{HVAC} \leq {m}_{i}^{max} \qquad ( 29 )$$

$${T}_{min}^{HVAC} \leq {T}_{i}^{HVACs} \leq {T}_{max}^{HVAC} \qquad ( 30 )$$

Where P ₜ^{HVAC} is an electric power consumed by the HVAC system in the commercial buildings; Pₜ^{h} is an electric power consumed by a HVAC heating system in the commercial buildings; COP is conversion efficiency; P ᵢ^{f} is an electric power consumed by a HVAC air supply system in the commercial buildings; ,ΔPₜₒₜ is a pressure difference of the HVAC air supply system; η_{fan} is a fan coefficient of HVAC equipment; ηₘₒₜₒᵣ is a motor coefficient of the HVAC equipment; ρₐᵢᵣ is the air supply density; v is an air supply flow velocity; Tₘᵢₙ^{HVAC} and Tₘₐₓ^{HVAH} are upper and lower limits of an air supply temperature of the HVAC system; P_{static} is a static pressure difference; mᵢ^{min} and mᵢ^{max} are lower and upper limits of an air supply mass flow rate.

In order to meet the users' requirements for comfort, the indoor temperature should be kept within a comfort range:

Tᵢ^{rmin}≤Tᵢ^{r}≤Tᵢ^{rmax} (31)

Where Tₗ^{rmin} and Tₗ^{rmax} are lower and upper limits of the indoor temperature.

3) Building an aggregation formula of the commercial buildings and the residential buildings:

$${P}_{j}^{EEn} \cdot {η}_{EEn} = {\sum }_{i = 1}^{{N}_{EB μ}} {P}_{t}^{HVAC} \qquad ( 32 )$$

$${Φ}_{j}^{HEn} \cdot {η}_{HEn} = {\sum }_{i = 1}^{{N}_{HB μ}} {Q}_{R , i} \qquad ( 33 )$$

Where Pⱼ^{EEn} is an electric load of the commercial building matched to a power distribution sub-network; Φⱼ^{HEn} is a heat load of the residential building matched to a heating sub-network; η_{EEn} and η_{HEn} are conversion coefficients of the commercial building and the residential building respectively; N_{EBu} is a set of the commercial buildings; and N_{HBu} is a set of the residential buildings.

204: In order to realize coordinated operation of a RIEDHS with multiple operating entities, an ADMM is used to complete information interactions among the operating entities in a distributed way, wherein a main problem is transformed into sub-problems of the electricity sub-network and the heating sub-network, and the electricity sub-network and the heating sub-network perform internal local optimization according to the respective sub-problems;

Step 204 comprises:

1) Building objective functions of the electricity sub-network and the heating sub-network:

The ADMM distributed method transforms an original problem into a general consistency problem, transforms an original objective function into an augmented Lagrange function, and introduces a coupling variable and a global variable to solve the problem.

The objective function of the electricity subsystem is:

$${min ( {\sum }_{t = 1}^{T} ( {\sum }_{i = 1}^{{N}_{PG}} {F}_{Gi} + {\sum }_{k = 1}^{{N}_{PG}} {F}_{pvi} ) )}^{k + 1} + {\sum }_{mn ∈ {S}_{EH}} {λ}_{mn , i}^{k} ( {x}_{E}^{k + 1} - {z}_{mn}^{k} ) + \frac{ρ}{2} {\sum }_{mn ∈ {S}_{EH}} {‖ {x}_{E}^{k + 1} - {z}_{mn}^{k} ‖}_{2}^{2} \qquad ( 34 )$$

Where T is a scheduling period; N_{PG} is a set of generators; F_{Gi} represents electricity purchase cost of the system from a power transmission network; Fₚᵥᵢ is output cost of photovoltaic power generation equipment; λ_{mn,i}^{k} is a Lagrange multiplier in the electricity subsystem; x_{E}^{k+1} is the coupling variable in the electricity subsystem; zₘₙ^{k} is the global variable; p is a penalty parameter; SEH is a set of electrothermal coupling devices; and k is the number of iterations.

The electricity purchase cost of the system from the transmission network and the output cost of photovoltaic power generation equipment are specifically expressed as follows:

F_{Gi}=c_{Gi}P_{Gi,t} ∀Gi∈ S_{PG} (35)

Fₚᵥᵢ=cₚᵥᵢP_{pvi,s} ∀pvi∈ Sₚᵥ (36)

Where C_{G}I is a real-time electricity price of the power grid; cₚᵥᵢ is a cost coefficient of the photovoltaic power generation equipment; S_{PG} is a set of the generators; and Sₚᵥ is a set of the photovoltaic power generation equipment.

The objective function of the heating subsystem is:

$${min ( {\sum }_{t = 1}^{T} ( {\sum }_{g = 1}^{{N}_{CHP}} {F}_{ci} ) )}^{k + 1} + {\sum }_{m n ∈ {S}_{EH}} {λ}_{mn , j}^{k} ( {x}_{H}^{k + 1} - {z}_{m n}^{k} ) + \frac{ρ}{2} {\sum }_{m n ∈ {S}_{EH}} {‖ {X}_{H}^{k + 1} - {z}_{m n}^{k} ‖}_{2}^{2} \qquad ( 37 )$$

Where F_{ci} represents the cost of purchasing natural gas by the system; λ_{mn,j}^{k} is the Lagrange multiplier in the heating subsystem; and x_{H}^{k+1} is the coupling variable in the heating subsystem.

The cost of purchasing the natural gas by the system is as follows:

F_{ci}=c_{ci}n_{CH,}_{₄}_{i,t} ∀ci∈ S_{CHP} (38)

Where c_{ci} is the price of natural gas per cubic meter, and S_{CHP} is the set of CHP units.

2) Building the ADMM distributed method with the variable penalty parameter:

A few of extensions and variants of the ADMM distributed method can achieve better convergence performance in practical application. Using different penalty parameters in each iteration can improve the convergence performance of the ADMM and reduce dependence on selection of the initial penalty parameters. The basic principle is to consider the relative size of an ADMM original residual and a dual residual to change the penalty parameter:

$${ρ}^{k + 1} = \{ \begin{matrix}{ρ}^{k} \cdot ( 1 + {τ}^{incr} ) & if {‖ {r}^{k} ‖}_{2} > μ {‖ {s}^{k} ‖}_{2} \\ {ρ}^{k} \cdot {( 1 + {τ}^{decr} )}^{- 1} & if {‖ {s}^{k} ‖}_{2} > μ {‖ {r}^{k} ‖}_{2} \\ {ρ}^{k} & otherwise\end{matrix} \begin{matrix} \\ \\ \end{matrix} \qquad ( 39 )$$

Where: r^{k} represents the original residual; S^{k} represents the dual residual; T^{incr} and T^{decr} represent an increase-decrease coefficient of the penalty parameter; and μ represents the multiple of the difference between the original residual and the dual residual.

When the original residual and dual residual converge to zero, the residuals should be kept within μ as much as possible. As shown in an internal iterative process, the larger the ρ value is, the greater the penalty for violating original feasibility will be, so it tends to produce a small original residual. On the contrary, based on the definition of the dual residual, the smaller the p value is, the smaller the dual residual will be, but relatively the penalty for the original feasibility is reduced, resulting in a larger original residual. The adjustment solution will increase ρ by (1+T^{incr}) when the original residual appears to be large relatively to the dual residual, and will decrease ρ by (1+T^{decr}) when the original residual appears to be too small relatively to the dual residual.

3) For a multi-entity operation system, a general consistency optimization method of the ADMM is used, the information consistency of boundary nodes is controlled by finite global variables, and a RIEDHS distributed solution model is built:

Firstly, the RIEDHS distributed scheduling model considering different heating modes is established, and the required related parameters are input. Then, an upper layer CO initializes λ_{mn,i}^{k}, λ_{mn,j}^{k} and zₘₙ^{k}, and sends the information to EO and HO of lower layers. After receiving coupling information, the EO and HO of the lower layers conduct internal local optimization according to equations (34) and (37), and get relevant information of all electrothermal coupling devices, and send the information back to the upper layer CO. The CO judges whether the ADMM converges after receiving the coupling device information sent by the EO and the HO. If the dual residual and the original residual are less than a threshold, the iteration stops. Otherwise, the CO updates the global variable and the Lagrange multiplier through the equation, and continues the cycle until the ADMM converges and the cycle ends. Conditions of variable updating are:

zₘₙ^{k+1}=(1/2)(x_{E}^{k+1}+x_{H}^{k+1}) (40)

λ_{mn,i}^{k+1}=λ_{mn,i}^{k}+ρ(x_{E}^{k+1}−zₘₙ^{k+1}) (41)

λ_{mn,j}^{k+1}=λ_{mn,j}^{k}+ρ(x_{H}^{k+1}−zₘₙ^{k+1}) (42)

In each iteration, the information of the electrothermal coupling equipment (X_{E}^{k+1}, X_{H}^{k+1}) is received from the EO and the HO of the lower layers, and the CO checks whether the dual residual of the original residual converges. If a convergence condition is not met, the CO updates the global variable and the Lagrange multiplier, and then sends the updated information back to the EO and the HO. The updated information needs to meet the convergence condition:

∥s^{k+1}∥₂²=∥x_{E/H}^{k+1}−zₘₙ^{k+1}∥₂²≤ε₁ (43)

∥r^{k+1}∥₂²=∥(−ρ)(zₘₙ^{k+1}−zₘₙ^{k})∥₂²≤ε₂ (44)

Where ε₁ and ε₂ represent relative stopping thresholds of the dual residual and the original residual; and x_{E/H}^{k+1} is the coupling variable in the electricity subsystem and the heating subsystem.

The dual residual is defined as the difference between the electrothermal coupling variable and the global variable in each iteration. The smaller the difference is, the more accurate the information transmitted from the EO and HO of the lower layers to the upper-layer CO will be. The original residual is the difference between the global variables of two adjacent iterations. The smaller the difference is, the smaller the change amplitude of two iterations will be, and the closer the result is to global optimization.

In conclusion, the embodiment of the present invention can fully explore a demand response potential of commercial buildings and residential buildings on the premise of ensuring the temperature comfort through the above step 201 to step 204, provide additional operation flexibility for the RIEDHS, reduce the operation cost of the RIEDHS to a certain extent, and improve a photovoltaic utilization rate. Meanwhile, the ADMM method is introduced into the RIEDHS to solve the distributed optimization problem of the multi-entity operation system, which effectively protects the internal privacy of different operators and reduces the amount of information interactions among the different entities. By adopting the ADMM in the form of variable penalty parameters, the convergence performance of the algorithm is effectively improved, and the dependence on the initial value of penalty parameters is reduced, thereby further improving the calculation efficiency.

### Embodiment 3

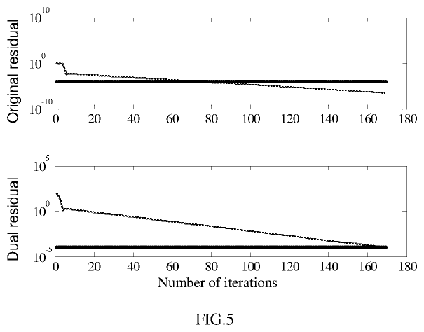

The feasibility of the solutions in Embodiments 1 and 2 is verified with specific embodiments, FIG. 4, FIG. 5, and Tables 1, 2 and 3. See the following description for details:

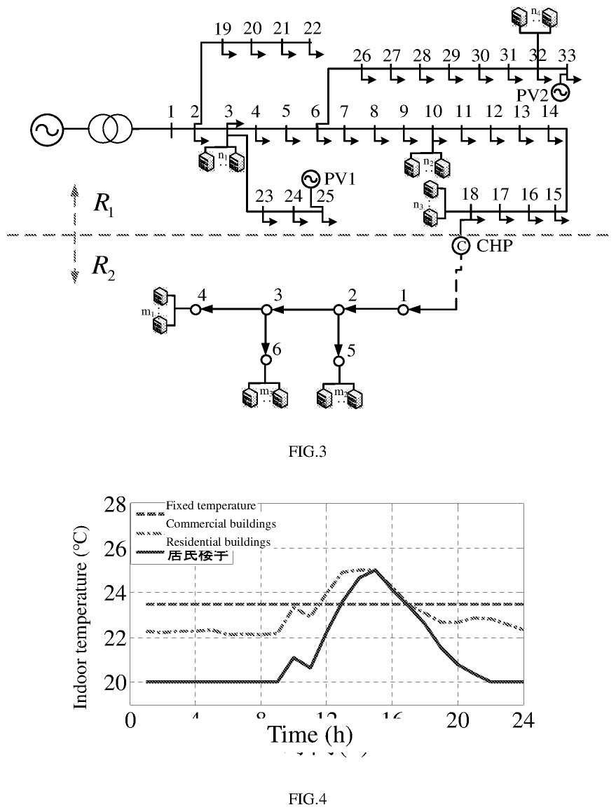

The embodiment takes a typical winter day in northern China as an example. A test system (called E33D6 system) consisting of an IEEE33-node power system and a 6-node district heating system was used to verify the effectiveness of a distributed optimization method of regional integrated energy considering different building heating modes. FIG.3 shows network topology of the E33D6 system, in which the 1^{st} node is a root node. A cogeneration device was connected to the 18^{th} node in the power system and connected to a photovoltaic power supply at 25^{th} and 33^{rd} nodes. A cogeneration unit provided heat energy to the 6-node district heating system.

Loads of commercial buildings and residential buildings were connected to an electricity subsystem and an heating subsystem respectively, in which 13 buildings, 9 buildings, 13 buildings and 30 buildings were connected to the 3^{rd} node, the 10^{th} node, the 18^{th} node and the 32^{nd} of the power grid respectively, and each heating area in the building is equipped with HVAC equipment to maintain user comfort; 60 residential buildings, 10 residential buildings and 43 residential buildings were connected to the 4^{th} node, the 5th node and the 6^{th} node of the heating network respectively, and each heating area in the building is supported by hot water supplied by a heat exchange station to maintain user comfort. The building in this paper was assumed to be a single-story building, wherein each building had 40 heating areas and similar temperature requirements, each floor had 5 heating areas, there were 8 floors, and each heating area was 8 meters long, 8 meters wide and 3 meters high. The comfort level of the heating area was 20-25° C. Related parameters (such as heating resistance) of a building HVAC system are listed in Table 1. Under the influences of a direct sunlight direction, the angle of an external window of the building, a shading coefficient and other factors, the paper assumed that an absorption coefficient a_{i,j}^{w} of the wall is 0.4 and the window transmittance τ_{wij} is 0.9.

TABLE 1
Related Parameters of Buildings and HVAC System

| R_{wall} | R_{wall(win)} | R_{win} | C_{wall} | C_{wall(win)} | Cᵣ |
|---|---|---|---|---|---|
| (K/W) | (K/W) | (K/W) | (J/K) | (J/K) | (J/K) |
| 0.1 | 0.13 | 0.03 | 7.90e+05 | 2.60e+07 | 2.50e+05 |

| ρₐᵢᵣ | Cₚₐᵢᵣ | | v | P_{static} | |
|---|---|---|---|---|---|
| (kg/m3) | (J/kg · ° C.) | COP | (m/s) | (Pa) | η_{fan} · ηₘₒₜₒᵣ |
| 1.29 | 1005 | 3 | 4 | 135 | 0.15 |

In order to verify the influence of heating inertia of the residential buildings and commercial buildings on RIEDHS scheduling results under an ADMM distributed method, the following four scenes were simulated:
Scene 1: Coordinated indoor constant-temperature scheduling was supported in the commercial buildings and residential buildings. The indoor temperature of all buildings was set to be 23.5° C.
Scene 2: The indoor temperature of the commercial buildings was adjustable, and the indoor temperature of the residential buildings was still constant, which was set at 23.5° C. The comfort level of users of the commercial buildings was 20-25° C. as required.
Scene 3: The indoor temperature of the residential buildings was adjustable, and the indoor temperature of the commercial buildings was constant, that is, regardless of heating inertia thereof, the value was set to 23.5° C. The comfort level of users of the residential buildings was 20-25° C. as required.
Scene 4: The indoor temperature of the commercial buildings and residential buildings was adjustable. Considering the heating inertia of the two types of buildings, the user comfort level was 20-25° C. as required.

Table 2 described comparison results of total cost and photovoltaic consumptions of each scene. Compared with Scene 2 and Scene 3, Scene 1 had higher total cost and less photovoltaic consumption. Scene 2 and Scene 3 used the heating inertia of commercial buildings and residential buildings to store heat during the period of low loads, thus reducing the power output of CHP units and using more photovoltaic output. Scene 4 made integral consideration of the influence of the buildings with two heating modes, wherein the total operating cost decreased from 9996.05$ to 9893.15$, and the photovoltaic consumption increased from 41.26MW to 42.54MW. Based on the above phenomena, it can be seen that the scheduling results of Scene 4 was subject to the lowest total cost and the largest photovoltaic consumption among the four solutions. In other words, the scene considering the indoor temperature adjustability of the commercial and residential buildings at the same time was more economical than considering no or only one case, thereby effectively improving the photovoltaic consumption.

TABLE 2
Related Parameters of Buildings and HVAC system

| Scene | Total cost ($) | Photovoltaic absorption (MW) |
|---|---|---|
| Scene 1 | 9996.05 | 41.26 |
| Scene 2 | 9977.78 | 41.71 |
| Scene 3 | 9911.38 | 42.09 |
| Scene 4 | 9893.15 | 42.54 |

As shown in FIG. 4, at different time, the indoor temperature in the commercial buildings and residential buildings reached the upper temperature limit (25° C.) and the lower temperature limit (20° C.). Although the indoor temperature reached the temperature limit, it was still within the comfort range of users. Compared with the fixed indoor temperature, the indoor temperature of the buildings with variable indoor temperature fluctuated to different degrees in the scheduling period, that is, the RIEDHS scheduling operation mode corresponding to Scene 4 was more flexible.

FIG. 5 shows an iterative process of an original residual and a dual residual of the E33D6 test system. As shown in FIG. 5, the convergence curves of the dual residual and the original residual of the E33D6 test system were uniformly reduced, the convergence trend was good, and the convergence time of the E33D6 test system was 149.30s, which proved the effectiveness of the method.

By comparing the convergence processes of the ADMM with standard and variable penalty parameters, the effectiveness thereof could be clearly verified. As shown in Table 3, the E33D6 test system was used to compare effects of different initial penalty parameters and relative stop thresholds on the convergence performance. As shown in Table 3, under the same relative stop threshold (ε₁/ε₂) and initial penalty parameter (ρ), the number of iterations and iteration time of ADMM with the variable penalty parameters were both less than those of the standard ADMM. For example, when the relative stop threshold was 10⁻³ and the initial penalty parameter was 3, the standard ADMM reached the maximum number of iterations and did not converge, which took 1046.1s. The ADMM with variable penalty parameters only needed 540 iterations, the convergence time was only 598.5s, and the convergence speed was improved by 42.79%. Meanwhile, the ADMM with the variable penalty parameters was less affected by the initial penalty parameter, and had better convergence performance in most cases. From this point of view, the ADMM with variable penalty parameters could obtain better convergence performance, improved the convergence speed and had less dependence on the initial selection of penalty parameters.

TABLE 3
Comparison between Standard ADMM and
ADMM with Variable Penalty Parameters

| | Initial penalty | | | |
|---|---|---|---|---|
| ADMM | parameter ρ | ε₁/ε₂ | Iterations | Iterative time |
| Standard | 10 | 10⁻² | 993 | 1307.3 |
| | 6 | 10⁻³ | max | 1090.4 |
| | 5 | 10⁻³ | 940 | 933.8 |
| | 3 | 10⁻³ | max | 1046.1 |
| Variable penalty | 10 | 10⁻² | 971 | 1137.2 |
| parameter | 6 | 10⁻³ | 633 | 713.3 |
| | 5 | 10⁻³ | 544 | 599.5 |
| | 3 | 10⁻³ | 540 | 568.5 |

The embodiments of the present invention do not limit the models of other devices except for special instructions on the models of each device, and the devices that can complete the above functions are applicable.

Those skilled in the art can understand that the attached drawings are only schematic diagrams of a preferred embodiment, and the above-mentioned embodiment numbers of the present invention are for description only, and do not represent the advantages and disadvantages of the embodiments.

Above descriptions are only the preferred embodiments of the present invention, and do not intend to limit the present invention. Any modification, equivalent replacement, improvement or the like made within the spirit and principle of the present invention should be included in the scope of protection of the present invention.

### REFERENCES

[1] Li Y, Wang C, Li G, Wang J, Zhao D, Chen C. Improving operational flexibility of integrated energy system with uncertain renewable generations considering heating inertia of buildings. Energy Conyers Manage 2020; 207:112526-40.
[2] Perez-Lombard L, Ortiz J, Pout C. A review on buildings energy consumption information. Energy and Buildings 2008; 40(3):394-98.
[3] Al-Ali A R, Zualkernan I A, Rashid M, Gupta R, Alikarar M. A smart home energy management system using loT and big data analytics approach. IEEE Trans Consum Electron 2017; 63(4):426-34.
[4] Salpakari J, Mikkola J, Lund P D. Improved flexibility with large-scale variable renewable power in cities through optimal demand side management and power-toheat conversion. Energy Conyers Manage 2016; 126:649-61.

What is claimed is:

1. A distributed optimization method of regional integrated energy considering different building heating modes, comprising the following steps:
based on a heating resistance and heat capacity network model, building an RIEDHS optimal scheduling model considering different building heating modes according to building heat storage characteristics and different heat energy supply forms in a room;
by a coordination operator, initializing a Lagrange multiplier and global variable information and sending related information to an electricity sub-network and a heating sub-network which perform internal local optimization according to respective sub-problems and return coupling variable information to the coordination operator;
by the coordination operator, receiving the coupling variable information from the electricity sub-network and the heating sub-network, judging whether a convergence condition is met according to the coupling variable information and global variable information: ending the process if so, otherwise updating the Lagrange multiplier and a global variable, and re-executing the local optimization step until the convergence condition is met.

2. The distributed optimization method of regional integrated energy considering different building heating modes according to claim 1, wherein based on the heating resistance and heat capacity network model, building the RIEDHS optimal scheduling model considering the different building heating modes specifically comprises:
1) building an indoor heat balance constraint of commercial buildings and residential buildings:
$${C}_{i}^{r} \frac{{dT}_{i}^{r}}{dt} = {\sum }_{j ∈ {N}_{i}^{r}} \frac{{T}_{i , j}^{w} - {T}_{i}^{r}}{{R}_{i , j}^{w}} + {π}_{i , j}^{r} {\sum }_{j ∈ {N}_{i}^{r}} \frac{{T}_{j} - {T}_{i}^{r}}{{R}_{i , j}^{win}} + {Q}_{i}^{int} + {Q}_{R , i} + {π}_{i , j}^{r} {τ}_{i , j}^{w} {A}_{i , j}^{win} {Q}_{i}^{rad}$$
$${C}_{i}^{r} \frac{{dT}_{i}^{r}}{dt} = {\sum }_{j ∈ {N}_{i}^{r}} \frac{{T}_{i , j}^{w} - {T}_{i}^{r}}{{R}_{i , j}^{w}} + {π}_{i , j}^{r} {\sum }_{j ∈ {N}_{i}^{r}} \frac{{T}_{j} - {T}_{i}^{r}}{{R}_{i , j}^{win}} + {Q}_{i}^{int} + {m}_{i}^{HVAC} {c}_{pair} ( {T}_{i}^{HVACs} - {T}_{i}^{r} ) + {π}_{i , j}^{r} {τ}_{i , j}^{w} {A}_{i , j}^{win} {Q}_{i}^{rad}$$
where: Cᵢ^{r} a heat capacity of an indoor room; Tᵢ^{r} is an indoor room temperature; π_{i,j}^{r} is equal to 0, which indicates that there is no window on walls of the indoor room, otherwise the value is 1; Qᵢₙₜᵢ is an internal heat source of the room; R_{i,j}^{win} is heating resistance of the window; mᵢ^{HVAC} is an air supply mass flow of an HVAC system; cₚₐᵢᵣ is a specific heat capacity of air; Tᵢ^{HVACs} is an air supply temperature; T_{i,j}^{w} is transmittance of the window; A_{i,j}^{win} represents the total area of the window; Q_{R,i} is a heating power required by the residential building; Qᵢ^{rad} is the intensity of illumination radiation;

2. building an aggregation formula of the commercial buildings and the residential buildings:
$${P}_{j}^{EEn} \cdot {η}_{EEn} = {\sum }_{i = 1}^{{N}_{EB μ}} {P}_{t}^{HVAC}$$
$${Φ}_{j}^{HEn} \cdot {η}_{HEn} = {\sum }_{i = 1}^{{N}_{HB μ}} {Q}_{R , i}$$
where: Pᵢ^{EEn} is an electric load of the commercial building matched to a power distribution sub-network; Φⱼ^{HEn} is a heat load of the residential building matched to a heating sub-network; η_{EEn} and η_{n HEn} are conversion coefficients of the commercial building and the residential building respectively; N_{EBu} is a set of the commercial buildings; and N_{HBu} is a set of the residential buildings.

3. The distributed optimization method of regional integrated energy considering different building heating modes according to claim 1, wherein the step that the electricity sub-network and the heating sub-network perform internal local optimization according to respective sub-problems specifically comprises:
using an ADMM to complete information interactions among operating entities in a distributed way, wherein a main problem is transformed into sub-problems of the electricity sub-network and the heating sub-network, and the electricity sub-network and the heating sub-network perform internal local optimization according to the respective sub-problems.

4. The distributed optimization method of regional integrated energy considering different building heating modes according to claim 3, wherein using the ADMM to complete the information interactions among the operating entities specifically comprises:
establishing an RIEDHS distributed optimal scheduling model considering different building heating modes, and inputting required related parameters;
by a CO, initializing a Lagrange multiplier (λ_{mn,i}, λ_{mn,j}) and a global variables (zₘₙ) of each subregion and sending information to an EO and a HO of lower layers;
after receiving the coupling information, by the EO and HO of the lower layers, conducting internal local optimization to obtain all information ((x_{E}^{k+1}, x_{H}^{k+1}) of electrothermal coupling equipment, and then by the EO and HO, respectively sending the information of the electrothermal coupling equipment back to the CO;
by the CO, judging convergence of the ADMM after receiving the information of the electrothermal coupling equipment sent by the EO and HO, wherein iteration is stopped if a dual residual and an original residual are less than a threshold; and
∥s^{k+1}∥₂²=∥x_{E/H}^{k+1}−zₘₙ^{k+1}∥₂²≤ε₁
∥r^{k+1}∥₂²=∥(−ρ)(zₘₙ^{k+1}−zₘₙ^{k})∥₂²≤ε₂
convergence condition is not met, the CO updates the global variable and the Lagrange multiplier, and then sends the updated information back to the EO and HO until the ADMM converges and the cycle ends.
zₘₙ^{k+1}=(1/2)(x_{E}^{k+1}+x_{H}^{k+1})
λ_{mn,i}^{k+1}=λ_{mn,i}^{k}+ρ(x_{E}^{k+1}−zₘₙ^{k+1})
λ_{mn,j}^{k+1}=λ_{mn,j}^{k}+ρ(x_{H}^{k+1}−zₘₙ^{k+1}).
